(19) United States
(12) Patent Application Publication
(10) Pub. No.: US 2005/0050342 A1
(43) Pub. Date: Mar. 3, 2005

(54) Secure storage utility

(75) Inventors: Richard H. Boivie, Monroe, CT (US); William Eric Hall, Clinton, CT (US)

Correspondence Address: SCULLY SCOTT MURPHY & PRESSER, PC, 400 GARDEN CITY PLAZA, GARDEN CITY, NY, 11530, US

(73) Assignee: INTERNATIONAL BUSINESS MACHINES CORPORATION, ARMONK, NY (US)

(21) Appl. No.: 10/639,943

(22) Filed: Aug. 13, 2003

(51) Int. Cl. G06F 12/14

(52) U.S. Cl. 713/193; 713/181

(57) ABSTRACT

A system and method implementing advanced cryptographic techniques to protect both the confidentiality and integrity of data sent to and received from a storage system or storage utility. Particularly, the system and method provides for the privacy and integrity of stored data. The integrity protection scheme employed defends against modification of data as well as “replay” and “relocation” of data since cryptographic integrity values are not only a function of the plaintext data and a cryptographic key, but also a function of the “address” of the disk block and a “whitening” value that defends against “replay attacks”. The integrity scheme protects the integrity of an entire virtual disk while allowing incremental, random access updates to the blocks on the virtual disk.

### BACKGROUND OF THE INVENTION

1. Field of the Invention

The present invention is directed to data storage systems, and particularly to a novel storage utility in which the confidentially and integrity of information is protected.

2. Description of the Prior Art

A business IT infrastructure must be flexible and “responsive” so that a business can rapidly adapt to marketplace changes and other changes in business conditions and it must be resilient since IT infrastructure is increasingly “mission critical”. A storage utility can provide this flexibility, responsiveness and resilience and it can also allow a business to focus on its core competencies and outsource its storage needs to a specialist. A storage utility can be flexible and responsive to a business's storage needs dynamically providing more storage or less storage as needed and providing a variable cost structure based on the amount of storage used. The storage utility can also provide resilience by providing disk “mirroring” and backup and recovery services. But a business may be hesitant to employ a storage utility if it has concerns about the security of its data. It may not want the utility or its employees to be able to “see” its confidential data and it may have concerns about the utility's ability to protect the integrity of its data from accidental or intentional modification.

It would be highly desirable to provide a secure storage utility that addresses these concerns.

### SUMMARY OF THE INVENTION

It is an object of the invention to provide a secure data storage utility that implements a novel security encryption scheme running on a business's (client or server) computer that encrypts data blocks prior to communicating them for storage in a storage media device.

Preferably, according to one aspect of the invention, data is encrypted on the business's (client or server) computers before a disk block is written out to the storage utility and decrypted after it is read back in from the storage utility. The decryption process includes an integrity check. In one embodiment, the integrity protection scheme employed defends against modification of data as well as “replay” and “relocation” of data since cryptographic integrity values are not only a function of the plaintext data and a cryptographic key, but also a function of the “address” of the disk block and another value (described below) that defends against “replay attacks”. The integrity scheme protects the integrity of an entire virtual disk while allowing incremental, random access updates to the blocks on the virtual disk. The integrity scheme employs a hierarchical tree of integrity values that is updated incrementally when blocks are written to the virtual disk. The integrity scheme is highly efficient and thus allows security, including confidentiality and integrity to be added to the storage utility without significantly adding to system cost or to the time it takes to read and write data.

Advantageously, the system and method of the invention efficiently protects both the privacy and integrity of a business's data and is important for businesses that would like to take advantage of the benefits of a storage utility but have concerns about the security and integrity of their data.

### BRIEF DESCRIPTION OF THE DRAWINGS

Further features, aspects and advantages of the apparatus and methods of the present invention will become better understood with regard to the following description, appended claims, and accompanying drawings where:

FIG. 1 depicts a secure storage area network system 10 implementing the storage utility of the present invention;

FIG. 2 illustrates an encryption scheme 30 for reading data from the storage utility device and a scheme for writing data from the server to the storage device in accordance with the invention;

FIG. 3 is a schematic diagram depicting the data storage integrity scheme in accordance with an embodiment of the invention;

FIG. 4 illustrates the steps involved in writing a disk block to the storage utility in accordance with an embodiment of the invention; and,

FIG. 5 illustrates the steps involved in reading a disk block from the storage utility in accordance with an embodiment of the invention.

### DETAILED DESCRIPTION OF THE PREFERRED EMBODIMENT

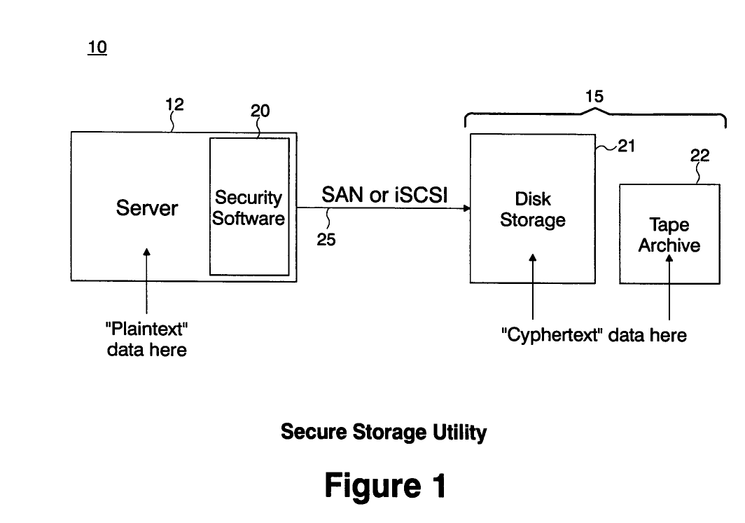

FIG. 1 depicts a secure storage area network system 10 implementing the storage utility of the present invention. As shown in FIG. 1, a data source providing the plaintext data to be stored in the storage utility 15 implementing storage media such as disk 21 and tape 22, for example, resides in a device such as server device 12. It is understood that other non-volatile types of storage media, e.g., optical, magnetic, compact, Flash disks, etc. may be implemented and, as well, volatile storage media. A block of data that is written out to the storage utility is encrypted according to a process provided in a security software program 20 executing at the server to generate ciphertext for storage in the storage utility 15. In one embodiment, the server device 12 provides a network interface operating at server device 12 in accordance with storage area network communications standards such as Fiber channel or iSCSI over a communications network connection 25. Preferably the converted cipher text has been encoded by the storage encryption software according to an encryption scheme designed to protect both the confidentiality and integrity of a data block and includes “time” and location sensitivity to defend against “replay” and “relocation” of data. (A “replay” of a data block is the replacement of a data block with a value that was valid at that data block's address at some earlier point in time. A “relocation” of a data block is the replacement of a data block with a block that is valid at another address). The encryption scheme utilizes an encryption algorithm such as DES or AES.

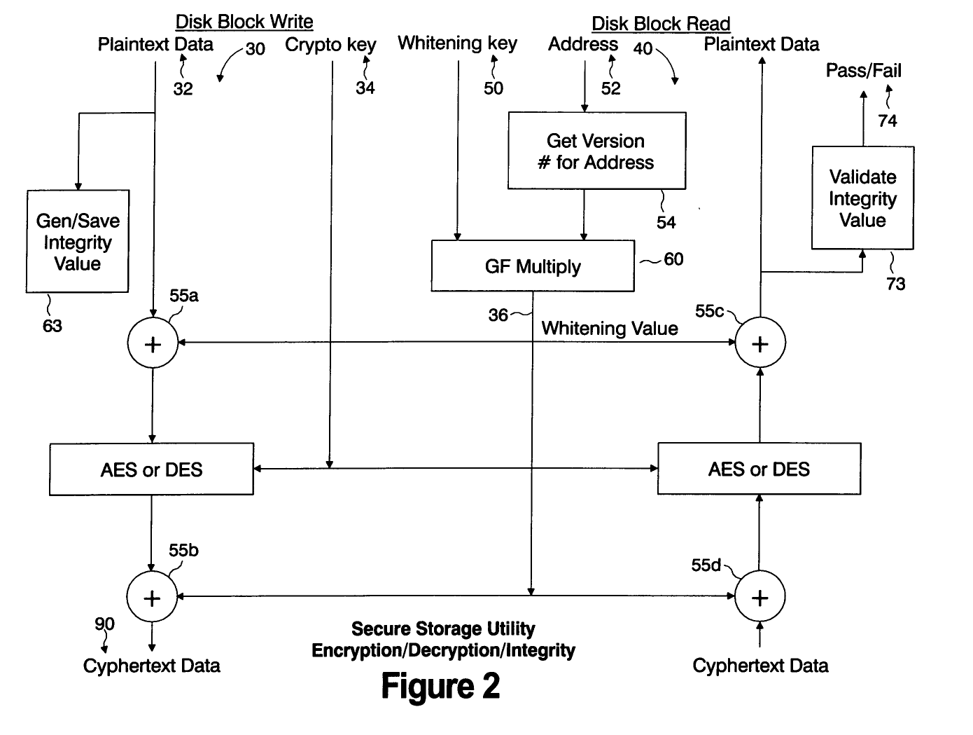

FIG. 2 illustrates an encryption scheme 40 for reading data from the storage utility device and a scheme 30 for writing data from the server to the storage device. As shown in FIG. 2, the encryption of a plaintext block to form storage ciphertext 90 is a function of the plaintext data 32, an encryption key 34 and a “whitening” value 36 which is a function of a whitening key 50, the block's “address” 52 and a “version number” value 54 which is the value of a counter that is incremented each time a block is written. The use of the block's address 52 in the whitening value defends against relocation and the use of the version number 54 defends against replay. In one variant of this scheme, as shown in FIG. 2, the whitening value is a finite field multiplication 60 in a Galois Field, which corresponds to multiplication of polynomials modulo an irreducible polynomial of degree 128 for AES or degree 64 for DES, of the version number and the whitening key (See, for instance, a reference entitled “Theory and Practice of Error Control Codes” by Richard E. Blahut, Chapter 4—The Arithmetic of Galois Fields). In the variant of the scheme described herein with respect to FIG. 2, whitening includes application of an exclusive-OR 55a of the data with the whitening applied to the data both before 55a and after 55b the DES or AES encryption on disk writes as well as before 55d and after 55c the DES or AES decryption on disk reads. An integrity value 63 is also computed and stored at the client whenever a block is written out to the storage utility. The integrity value can be a sum (an “exclusive OR”, for example) of all the plaintext in the disk block. As will be explained in further detail herein, FIG. 2 illustrates that for a disk block read operation, that block's validity is calculated and checked 73 against the saved integrity value for that block and a pass/fail indication 74 is generated for that block in response to the comparison.

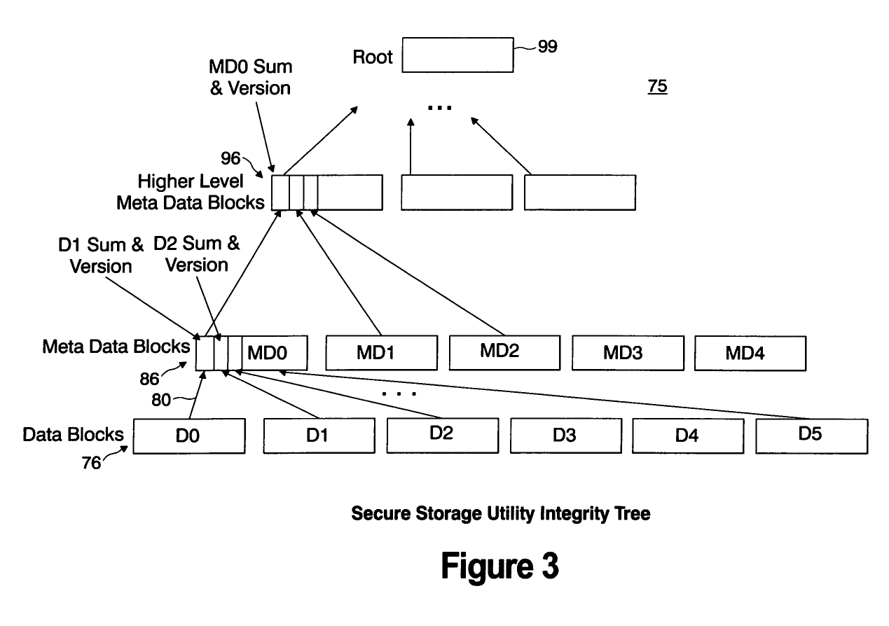

FIG. 3 illustrates the data storage integrity scheme 75 according to the present invention. As shown in FIG. 3, the integrity value for a disk block DO 76, also needs to be protected if the disk block itself is to be protected. As the version number also needs to be maintained and protected, an <integrity value, version number> pair 80 is saved for a given block 76. This pair is combined with similar pairs of other (nearby) disk blocks and written to a “meta-data” disk block 86. The “meta-data” disk block 86 in turn must be protected. In one variation of this data storage integrity scheme 75 illustrated in FIG. 3, the <integrity value, version number> pair for this meta-data disk block is combined with those of other nearby meta-data blocks and written to a higher-level meta-data block 96 which is in turn protected. This process continues in a manner such that a meta-data block hierarchy is formed comprising blocks including the higher-level meta-data blocks 96 which form a data structure referred to as an integrity tree having a root data structure 99 which protects the integrity of the entire virtual disk. Although one particular design for an integrity tree is shown in FIG. 3, it is understood that alternative designs are also possible. For example, an integrity tree such as that described in commonly-owned, co-pending U.S. patent application Ser. No. ______ (Docket No. YOR820020283) entitled Parallelizable Authentication Tree for Random Access Storage, the whole contents and disclosure of which is incorporated by reference as if fully set forth herein, may be alternately employed. Other integrity tree designs are also possible.

The root 99 of the integrity tree as well as the encryption and whitening keys are stored on the “customer” (client or server) computer that uses the storage utility. Furthermore, the contents of the meta-data integrity tree are updated and verified on the customer computer. This means that although the utility can backup and restore customer data, archive it on tape, and restore it from tape, the utility has no visibility into the customer's data. This also means that the customer can detect any accidental or intentional modification of the data that may have occurred at the storage utility including any “replay” or relocation” of data. It is understood that the “customer” and the “storage utility” need not belong to separate enterprises. The storage utility may be provided by the IT organization within an enterprise but in a way that provides “compartmentalization” of data so that any data managed by the IT organization is only “visible” to the party that “owns” the data.

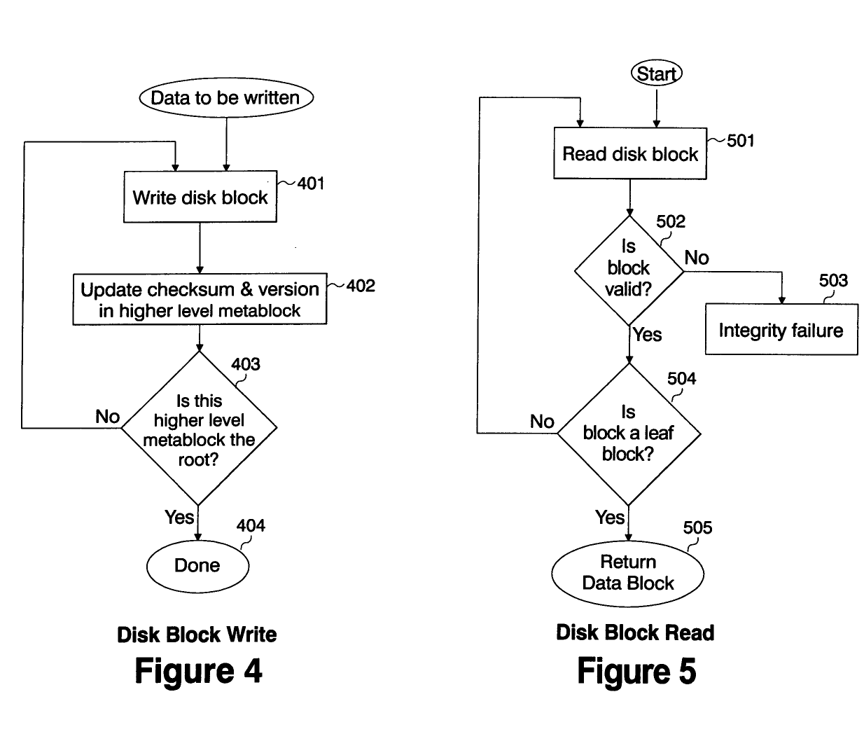

FIG. 4 illustrates the steps involved in writing a disk block to the storage utility. In a first step 401, a data block is written to the storage utility. In step 402, updated versions of the data block's checksum and version number are saved in the data block's “meta-data” block. A determination is made at step 403 to determine whether this meta-data block corresponds to the root of the integrity tree. If the meta-data block is the root of the integrity tree, then the process completes at step 404. If, on the other hand, the meta-data block is not the root of the integrity tree, then the meta-data block is written out to the storage utility as in step 401, and the checksum and version number for that meta-data block is saved at the next higher-level meta-data block at step 402. As before, if this higher-level meta-data block corresponds to the root, as determined in step 403, the process completes at step 404. Otherwise, the meta-data block needs to be written out to the storage utility and the process continues until a higher level meta-data block corresponds to the root at which point the process terminates at step 404. It is understood that, in this process, all the blocks that are written out to the storage utility are protected using the encryption and integrity scheme described with respect to FIG. 2.

FIG. 5 illustrates the steps involved in reading a disk block from the storage utility. In step 501, the first disk block on the path from the root of the integrity tree to the desired data or leaf disk block is read from the storage utility. At step 502, the block's validity is checked with checksum and version information from the root of the integrity tree. If the integrity check fails, an integrity failure condition is signaled in step 503. On the other hand, if the block is determined to be valid, then a check is performed in step 504 to determine whether the block is the desired data or “leaf” block. If it is, the data is returned to the user in step 505. If the block is not the desired data block, the next disk block on the path from the root to the desired data block is read at step 501. As before, the integrity of this block is checked in step 502. As before, an integrity failure condition is signaled in step 503 if the integrity check fails. As before, if the block is determined to be valid, a check is performed, in step 504, to determine whether the block is the desired data block. If it is, the data is returned to the user in step 505. If not, the next disk block on the path is read and so on until either an integrity check fails in which case an integrity failure condition is signaled in step 503, or the desired data block is reached and the data is returned to the user in step 505. It is understood that all the blocks that are read from the storage utility are decrypted and have their integrity checked as described herein with respect to FIG. 2.

Note that disk blocks on the path from the root to the data disk blocks can be cached to improve performance. Note too, that with a modified integrity tree, such as the one described in co-pending patent application, YOR820020483, Parallelizable Authentication Tree for Random Access Storage, the integrity of disk blocks on the path from the root to the desired data can be checked in parallel, further improving performance.

According to one aspect of the invention, the secure storage utility operates on-demand whereby the customer may have an arbitrary amount of storage “on demand” that the customer pays for based on usage. The customer will receive a virtual disk, for instance, that includes an arbitrary number of disk blocks (which that customer may access via a SAN or iSCSI connection as shown in FIG. 1, for example). The number of disk blocks may be very large and the disk blocks may be spread over a large number of physical disks. The confidentiality and integrity of any data that is stored on this virtual disk is protected in the manner as described. The operator of the utility may perform data backup (e.g., on disk or tape) and can restore it if necessary and can replicate it at a bunch of places for reliability, disaster recovery and/or performance reasons. However, according to the invention, the operator cannot “see” any of the data and cannot modify it (i.e. the operator cannot modify it without detection). The privacy and integrity of the data stored in the storage utility is protected whether it's on disk or on tape. This is because the encryption/integrity scheme used protects both the confidentiality and integrity of the data. According to the invention, the master encryption key is in the customer's computer and the operator of the storage utility does not have access to that key.

Thus, in operation, data is encrypted on the customer's computer when it's written out to the storage utility and it is decrypted when it is read back in from the storage utility. The decryption step includes an integrity check so that data integrity is protected. It is understood that the security described is end-to-end since data is encrypted before it leaves the customer site and it is decrypted only after it arrives back at the customer site. Thus, there is no opportunity for a “man in the middle attack” at the storage utility even if the storage utility is part of a separate enterprise. The storage utility could also be provided by the IT organization within an enterprise and the storage utility hardware and software described may provide “compartmentalization” so that the data stored by the IT organization could only be accessed by appropriate parties. In addition to providing the hardware and software at the storage utility, “virtual disk driver” software at the customer end may be provided that reads and writes (and encrypts, decrypts and validates) data that is written to and read from the virtual disk at the storage utility. To enhance performance, encryption hardware may be provided at the customer end (in the processor itself or in a network adapter) to increase the performance of cryptographic and integrity operations on writes to and reads from the virtual disk. In the model described, the utility end does not require as much processing as the bulk of the encryption and integrity checking occurs at the customer end. To further enhance performance, the integrity tree or portions of the integrity tree may be cached at the customer end.

While the invention has been particularly shown and described with respect to illustrative and preferred embodiments thereof, it will be understood by those skilled in the art that the foregoing and other changes in form and details may be made therein without departing from the spirit and scope of the invention that should be limited only by the scope of the appended claims.

1. A system for secure data storage and retrieval comprising:
a storage device for storing encrypted data;
means at a client device for encrypting data prior to writing data blocks at said storage device, said encrypting means employing encryption capable of protecting individual data blocks against modification, relocation and replay for each data block written to said storage device;
means for generating an integrity value corresponding to one or more data blocks, said integrity value comprising information for preventing modification of data for each data block written to said storage device;
means for storing said integrity values of written data blocks;
means at said client device for decrypting said encrypted data accessed from said storage device; and,
means for performing an integrity check at said client device utilizing stored integrity values corresponding to stored data blocks being accessed, wherein said integrity check protects the integrity of contents stored in said storage device.

2. The system as claimed in claim 1, wherein said encryption means generates encrypted cipher text data blocks that are a function of plaintext data included in said data block and a first encryption key.

3. The system as claimed in claim 2, wherein said encryption means implements a whitening value which is a function of a second encryption key, an address location for said storage block, and a version number indicating a block write increment, said encryption means further generating cipher text data blocks that are additionally a function of said whitening value.

4. The system as claimed in claim 2, wherein said encryption means employs an algorithm including one selected from DES or AES encryption schemes.

5. The system as claimed in claim 3, wherein said means for storing said integrity values of written data blocks further includes means for generating an integrity tree structure, said integrity tree structure storing integrity values corresponding to each disk block written to said storage device.

6. The system as claimed in claim 5, wherein said integrity tree comprises a hierarchical data structure, said hierarchical data structure including two or more layers of integrity data structures, each successive layer of integrity data structures including meta-data protecting integrity of data at an immediate prior layer.

7. The system as claimed in claim 6, wherein said hierarchical data structure includes said written encrypted data blocks at a first layer, and a succeeding layer of meta-data blocks, each meta-data block including data structures representing a plurality of disk blocks written at said first layer, each meta-data block data structure comprising an integrity value and a version number pair for each of said plurality of disk blocks.

8. The system as claimed in claim 7, wherein said integrity tree includes a succeeding layer of higher level meta-data blocks for protecting a layer of meta-data blocks below, each higher level meta-data block comprising data structures representing a plurality of meta-data blocks, each higher level meta-data block data structure comprising an integrity value and version number pair generated for each of said plurality of meta-data blocks.

9. The system as claimed in claim 6, wherein a top layer of said hierarchical data structure includes a root data structure for protecting integrity of all content written to said storage device.

10. The system as claimed in claim 9, further comprising means for writing a data block to said storage device, said writing comprising means for updating a written data block's version number and checksum in the associated meta-data blocks, wherein updates to checksum and version number values are performed at each successive meta-data layer corresponding to said written data block, including updating performed at said root data structure.

11. The system as claimed in claim 9, wherein said means for performing an integrity check comprises means comparing integrity of data blocks to be read on a path from said root data structure via successive higher meta-data blocks and meta-data block layers until a desired data block at a first layer is read.

12. The system as claimed in claim 1, wherein said storage device comprises a non-volatile or volatile storage device.

13. The system as claimed in claim 1, wherein said storage device is remotely located from said client device, said encrypted blocks being written across a network link.

14. A method for secure data storage and retrieval comprising the steps of:
a) encrypting data to be written from a client device to a storage device for storing encrypted data, said encrypting utilizing an encryption scheme capable of protecting individual data blocks against modification, relocation and replay for each data block written to said storage device;
b) generating an integrity value corresponding to one or more written data blocks, said integrity value comprising information for preventing modification of data for each data block written to said storage device;
c) storing said integrity values of written data blocks;
d) decrypting the encrypted data accessed from said storage device; and,
e) performing an integrity check utilizing said stored integrity values corresponding to stored data blocks being accessed, said integrity check protecting the integrity of contents stored in said storage.

15. The method as claimed in claim 14, wherein said encrypting data step a) includes generating encrypted cipher text data blocks that are a function of plaintext data included in said data block and a first encryption key.

16. The method as claimed in claim 15, wherein said encrypting data step a) further includes generating a whitening value as a function of a second encryption key, an address location for said storage block, and a version number indicating a block write, and the generation of cipher text data blocks that are a function of said whitening value.

17. The method as claimed in claim 15, wherein said encrypting step a) further employs an algorithm including one selected from DES or AES encryption schemes.

18. The method as claimed in claim 14, wherein said storing step c) further includes the step of: generating an integrity tree structure for storing integrity values corresponding to each disk block written to said storage device.

19. The method as claimed in claim 18, wherein said integrity tree structure comprises a hierarchical data structure, said hierarchical data structure including two or more layers of integrity data structures, each successive layer of integrity data structures including meta-data protecting integrity of data at an immediate prior layer.

20. The method as claimed in claim 19, further comprising the step of: writing encrypted data blocks at a first layer of said hierarchical data structure, and writing a succeeding layer of meta-data blocks, each meta-data block including data structures representing a plurality of disk blocks written at said first layer, each meta-data block data structure comprising an integrity value and a version number pair for each of said plurality of disk blocks.

21. The method as claimed in claim 20, further comprising the step of: writing a succeeding layer of higher level meta-data blocks for protecting a layer of meta-data blocks below, each higher level meta-data block comprising data structures representing a plurality of meta-data blocks, each higher level meta-data block data structure comprising an integrity value and version number pair for each of said plurality of meta-data blocks.

22. The method as claimed in claim 21, further comprising the step of: generating a root data structure at a top layer of said hierarchical data structure for protecting integrity of all content written to said storage device.

23. The method as claimed in claim 22, further comprising the steps of: writing a data block to said storage device, said writing including updating a written data block's version number and checksum in the associated meta-data blocks, and, said checksum and version number value updating being performed at each successive meta-data layer corresponding to said written data block, including updating performed at said root data structure.

24. The method as claimed in claim 22, further comprising the step of: reading a data block from said storage device, said step e) of performing an integrity check including comparing integrity of data blocks to be read on a path from said root data structure via successive meta-data block layers until a desired data block is read from said first layer of said hierarchical data structure.

25. A program storage device readable by a machine, tangibly embodying a program of instructions executable by the machine to perform method steps for securely storing and accessing data, said method steps comprising the steps of:
a) encrypting data to be written from a client device to a storage device for storing encrypted data, said encrypting utilizing an encryption scheme capable of protecting individual data blocks against modification, relocation and replay for each data block written to said storage device;
b) generating an integrity value corresponding to one or more written data blocks, said integrity value comprising information for preventing modification of data for each data block written to said storage device;
c) storing said integrity values of written data blocks;
d) decrypting the encrypted data accessed from said storage device; and,
e) performing an integrity check utilizing said stored integrity values corresponding to stored data blocks being accessed, said integrity check protecting the integrity of contents stored in said storage device.

26. The program storage device readable by a machine as claimed in claim 25, wherein said encrypting data step a) includes generating encrypted cipher text data blocks that are a function of plaintext data included in said data block and a first encryption key.

27. The program storage device readable by a machine as claimed in claim 25, wherein said encrypting data step a) further includes generating a whitening value as a function of a second encryption key, an address location for said storage block, and a version number indicating a block write increment, said encrypting step generating cipher text data blocks that are additionally a function of said whitening value.

28. The program storage device readable by a machine as claimed in claim 27, wherein said storing step c) further includes the step of: generating an integrity tree structure for storing integrity values corresponding to each disk block written to said storage device, said integrity tree structure comprising a hierarchical data structure including two or more layers of integrity data structures, each successive layer of integrity data structures including meta-data protecting integrity of data at an immediate prior layer.

29. The program storage device readable by a machine as claimed in claim 28, further comprising the step of: writing encrypted data blocks at a first layer of said hierarchical data structure, and writing a succeeding layer of meta-data blocks, each meta-data block including data structures representing a plurality of disk blocks written at said first layer, each meta-data block data structure comprising an integrity value and a version number pair for each of said plurality of disk blocks.

30. The program storage device readable by a machine as claimed in claim 29, further comprising the steps of: writing a succeeding layer of higher level meta-data blocks for protecting a layer of meta-data blocks below, each higher level meta-data block comprising data structures representing a plurality of meta-data blocks, each higher level meta-data block data structure comprising an integrity value and version number pair for each of said plurality of meta-data blocks; and, generating a root data structure at a top layer of said hierarchical data structure for protecting integrity of all content written to said storage device.

31. The program storage device readable by a machine as claimed in claim 30, further comprising the steps of: writing a data block to said storage device, said writing including updating a written data block's version number and checksum in the associated meta-data blocks, and, said checksum and version number value updating being performed at each successive meta-data layer corresponding to said written data block, including updating performed at said root data structure.

32. The program storage device readable by a machine as claimed in claim 30, further comprising the step of: reading a data block from said storage device, said step e) of performing an integrity check including comparing integrity of data blocks to be read on a path from said root data structure via successive meta-data block layers until a desired data block is read from said first layer of said hierarchical data structure.
